(19) United States
(12) Patent Application Publication
(10) Pub. No.: US 2024/0219556 A1
(43) Pub. Date: Jul. 4, 2024

(54) METHOD FOR DETERMINING A SPEED OF TRAFFIC IN A ROUTE SECTION, DETECTION DEVICE, VEHICLE AND CENTRAL COMPUTER

(71) Applicant: CARIAD SE, Wolfsburg (DE)

(72) Inventor: David Alexander BADOUIN, Ingolstadt (DE)

(21) Appl. No.: 18/292,314

(22) PCT Filed: Jul. 26, 2021
(86) PCT No.: PCT/EP2021/070831

§ 371 Date: Jan. 25, 2024

(51) Int. Cl. G01S 13/58; G08G 1/01; G08G 1/052

(52) U.S. Cl. CPC G01S 13/58; G08G 1/0112; G08G 1/0141; G08G 1/052

(57) ABSTRACT

The disclosure relates to a method for determining a speed of traffic in a route section. In the method, a foreign driving speed of a foreign vehicle in the route section is determined at least once by a detection device of a detector vehicle according to a predetermined speed determination method, and traffic data including the foreign driving speed of the foreign vehicle in the route section are sent by the detection device to a central computer external to the detector vehicle.

### BACKGROUND

### Technical Field

The disclosure relates to a method for determining a speed of traffic in a predefined route section, a detection device, a vehicle comprising a detection device and a computer that constitutes a central computer for performing the method.

### Description of the Related Art

In order to assist a driver during a lane change maneuver, some vehicles are equipped with a lane change assistant. The lane change assistant is configured to monitor a predefined range of an adjacent lane of the route for approaching vehicles. If a foreign vehicle is approaching on the adjacent lane, within the predefined range, the lane change assistant warns the driver using predefined signals. A length of the predefined range depends on an assumed reaction time of the driver and an assumed maximum speed of vehicles on the adjacent lane. Usually the assumed maximum speed is based on a speed limit of a current route section. However, this assumption has several drawbacks.

In some route sections the speed limits are not respected by the drivers. Therefore the maximum speed may be higher than the speed limit of the route section. On the other hand the maximum speed of the vehicles may be lower than the speed limit of the route section. This may be the case in route sections with a high volume of traffic or bad road conditions. The maximum speed may also depend on a time of day and a season. These differences between the maximum speed and the speed limit in a route section may lead to an unsuitable length of the range used by the lane change assistant.

DE 10 2019 105 489 A1 discloses a method, device and computer program for providing information relating to an automated driving vehicle. The method comprises detecting a driving situation and/or determining a need for action when operating an automated vehicle. The method further comprises a provision of information on the detected driving situation and/or on the determined need for action on a selected computer unit external to the vehicle.

Document DE 10 2018 128 894 A1 describes a method, system and computer program for providing information for operating a vehicle, in particular by way of a digital map.

Document DE 10 2012 007 367 A1 describes a method for determining traffic and/or weather information for an application in the navigation and driver assistance system of the vehicle. The method involves the performance of a comparative analysis of traffic and/or weather information from traffic and/or weather information sources. The information which is applicable to a navigation system and/or a map-based driver assistance system is determined from the comparison result. Contents of information of one of the sources emerged modified selected adjusted and adapted for plausibility checking with that of information of other sources. The contents are utilized in the navigation and/or assistance system. The traffic and/or weather information sources are designed as a vehicle-to-infrastructure communication device and a central traffic and/or weather information source.

Document US 2016/0210854 A1 describes a device and a method for automatically updating the data base of driving speed limits. The document relates to a system and a method for updating a data base of authorized traffic speed limits for vehicles on at least on section of the road network. The system comprises the remote server and an on-board-system in each vehicle. The document also relates to a system and method capable of constituting a data base of the average traffic speeds of vehicles on said sections with a view to implementing the aforementioned system.

In the known systems vehicles of the systems record their own speeds when driving along a route section. Therefore a collection of speeds is restricted to vehicles participating in the systems.

### BRIEF SUMMARY

Embodiments of the present disclosure provide a method that can collect a larger volume of vehicle speed data in a route section.

The disclosure is related to a method for determining a speed of traffic in a route section. In other words the aim of the method is to investigate the speed of vehicles that drive along the route section. In the method a foreign driving speed of a foreign vehicle in the route section is determined at least once by a detection device of a detector vehicle or detecting vehicle according to a predetermined speed determination method. In other words the detection device of the detector vehicle measures at least once the foreign speed of the foreign vehicle. The detector vehicle may be configured as a car. The detection device may comprise a sensor device of the detector vehicle that may be configured to measure and/or determine the foreign driving speed of the foreign vehicle by way of the predetermined speed determination method. The foreign vehicle is a vehicle other than the detector vehicle comprising the detection device. The foreign vehicle may drive within a detection range of the detection device. Traffic data comprising the foreign driving speed of the foreign vehicle in the route section are sent by the detection device to a central computer external to the detector vehicle. In other words the detection device sends the traffic data from the vehicle to the central computer outside the detector vehicle. The transmission may be performed via mobile internet networks. In the traffic date the foreign driving speed of the foreign vehicle is comprised. Therefore the determined foreign driving speed of the foreign vehicle is transmitted to the central computer. The central computer is situated outside the detector vehicle and may be configured as a server or a server network. The disclosure has the advantage that the collection of speeds in the route section is not restricted to the detector vehicle comprising the detection but allows the collection of the foreign driving speed of the foreign vehicle. Therefore the detection device may collect a larger volume of data than common methods.

The detection device and the central computer may comprise a data processing device or a processor circuit adapted to perform an embodiment of the method according to the disclosure. For this purpose, the processor circuit may comprise at least one microprocessor and/or at least one microcontroller and/or at least one FPGA (field programmable gate array) and/or at least one DSP (digital signal processor). Furthermore, the processor circuit may comprise program code which comprises computer-readable instructions to perform the embodiment of the method according to the disclosure when executed by the processor device. The program code may be stored in a data memory of the processor device.

The disclosure comprises additional embodiments that provide features which afford additional technical advantages.

According to a further embodiment of the disclosure, the detection device of the detector vehicle detects at least two absolute positions of the foreign vehicle in the section of the route. In other words the predetermined speed determination process comprises at least two measurements of the absolute position of the foreign vehicle. The absolute positions describes geographic positions of the foreign vehicles. The absolute positions may be detected by the detection device using a predefined method to relate the position of the foreign vehicle in a photo taken by the detection device to a position of the foreign vehicle in a map. The detection device determines a foreign driving speed of the foreign vehicle in the route section from the at least two absolute positions of the foreign vehicle. The two absolute positions of the foreign vehicle are used by the detection device to calculate a distance between the at least two absolute positions. As the times of determination of the two absolute positions are known, it is possible to calculate the speed of the foreign vehicle.

According to a further embodiment of the disclosure during the predetermined speed determination method the detection device of the detector vehicle detects at least two relative positions of an foreign vehicle related to the detector vehicle in the section of the route. In other words the predetermined speed determination method comprises at least two measurements of the positions of the foreign vehicle with respect to the detector vehicle. The relative positions may comprise a distance to the detector vehicle and a direction to the detector vehicle. The detection device determines the foreign driving speed of the foreign vehicle in the route section from the at least two relative positions of the foreign vehicle and the current ego driving speed of the detector vehicle. A change in the relative positions of the foreign vehicle with respect to the detector vehicle allows the calculation of a speed of the foreign vehicle with respect to the detector vehicle. With the known ego driving speed of the detector vehicle it is possible to calculate the speed of the foreign vehicle by adding the ego driving speed of the detector vehicle to the relative speed of the foreign vehicle with respect to the detector vehicle.

According to a further embodiment of the disclosure during the predetermined speed determination method the relative foreign driving speed of the foreign vehicle in the route section is measured in a single measurement by the detection device. In other words the foreign driving speed of the foreign vehicle is measured by the detection device by way of a single measurement. The single measurement may comprise the determination of a Doppler shift of a reflected radar signal sent out by the detection device. The measurement of the Doppler shift allows a direct calculation of the relative foreign driving speed of the foreign vehicle with respect to the detector vehicle. The foreign driving speed of the foreign vehicle is calculated by the detection device using the relative foreign driving speed of the foreign vehicle and the current ego driving speed of the detector vehicle.

According to a further embodiment of the disclosure the data comprising the foreign driving speed of the foreign vehicle comprise information about a lane used by the foreign vehicle. In other words the data comprises information about the lane that is used by the foreign vehicle when driving along the route section. A determination of the lane used by the foreign vehicle may comprise a determination of a position of the foreign vehicle by using GPS and/or by detecting the lanes using a camera of the detection device. This embodiment provides the advantage that it is possible to assign the foreign driving speed of the foreign vehicle to the respective lane along the route section.

According to a further embodiment of the disclosure the data comprising the foreign driving speed of the foreign vehicle comprises a current speed limit of the route section at the moment of the measurement. In other words the data which comprise the foreign driving speed comprises a speed limit along the route section for the time the foreign driving speed of the foreign vehicle was measured. The disclosure has the advantage that a temporary speed limit may be considered during the analysis of the foreign driving speed. It is possible that the speed limit of the route section is limited for a specific time because of a construction site or an accident. By a transmission of the current speed limit a change of an average foreign driving speed of foreign vehicles along the route section may be related to the speed limit along the route section.

According to a further embodiment of the disclosure the traffic data are received by the central computer external to the detector vehicle. The foreign computer calculates speed data based on the traffic data and assigns the route section to predefined speed categories. The assigned speed categories are transmitted to an assisted vehicle comprising a lane change assistant by the central computer. In other words the central computer receives the traffic data provided by the detector vehicle. The central computer uses the received traffic data to calculate the speed data that are based on the traffic data. Based on the speed data, the central computer determines the speed category which fits to the route section. The central computer sends the speed data to the vehicle which comprises a lane change assistant.

The disclosure also comprises embodiments of the inventive detection device and the inventive detector vehicle that comprise features that correspond to features as they have already been described in connection with the embodiments of the inventive method. For this reason, the corresponding features of the embodiments of the inventive detection device method and the inventive vehicle are not described here again.

The inventive vehicle is preferably designed as a motor vehicle, in particular as a passenger vehicle or a truck, or as a bus or a motorcycle.

The disclosure also comprises the combinations of the features of the different embodiments.

### BRIEF DESCRIPTION OF THE SEVERAL VIEWS OF THE DRAWINGS

In the following an exemplary implementation of the disclosure is described.

FIG. 1 shows a schematic illustration of a method for determining a speed of traffic in a route section;

FIG. 2 shows a schematic illustration of a predefined lane change maneuver controlled or assisted by a lane change assistant; and

FIG. 3 shows a flowchart of a method for determining a speed of traffic in a route section.

### DETAILED DESCRIPTION

The embodiment explained in the following is an advantageous embodiment of the disclosure. However, in the embodiment, the described components of the embodiment each represent individual features of the disclosure which are to be considered independently of each other and which each develop the disclosure also independently of each other and thereby are also to be regarded as a component of the disclosure in individual manner or in another than the shown combination. Furthermore, the described embodiment can also be supplemented by further features of the disclosure already described.

In the figures identical reference signs indicate elements that provide the same function.

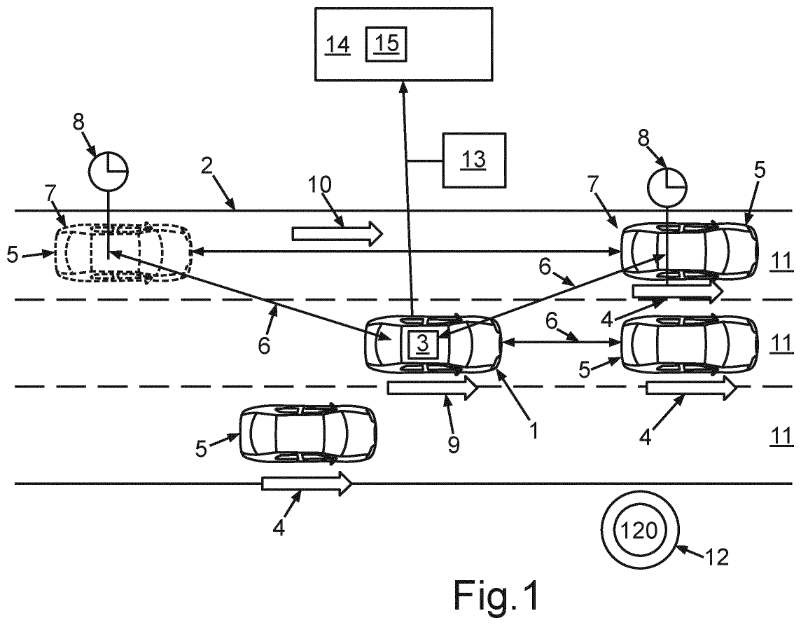

FIG. 1 shows a schematic illustration of a method for determining a speed of traffic in a route section. The FIG. 1 shows a detector vehicle 1 driving along a route section 2. The route section 2 may comprise several lanes for driving. The detector vehicle 1 may comprise a detection device 3 configured to detect a foreign driving speed 4 of a foreign vehicle 5. The foreign driving speed 4 of the foreign vehicle 5 may be determined by the detection device 3 using a predetermined speed determination method. The detection device 3 may comprise a LIDAR device, a radar device and/or a camera to detect the foreign vehicle 5. To determine the foreign driving speed 4 of the foreign vehicle 5 the detection device 3 may send out electromagnetic signals and receive the corresponding reflected signals to detect a distance 6 or a position 7 of the foreign vehicle 5 at two different times 8. The detection device 3 may be configured to receive or to determine the ego driving speed 9 of the vehicle 1. By comparing a change of the distance 6 of the foreign vehicle 5 to the detector vehicle 1 between the two different times 8, the detection device 3 may determine a relative speed 10 of the foreign vehicle 6 related to detector vehicle 1. The detection device 3 may combine the ego driving speed 9 of the detector vehicle 1 and the relative speed 10 of the foreign vehicle 5 related to the detector vehicle 1 to calculate the foreign driving speed 4 of the foreign vehicle 5. The detection device 3 may be configured to determine the foreign driving speed 4 of the foreign vehicle 5 by way of a Doppler effect that may be observable in a radar signal send out by the detection device 3 and received by the detection device 3 after being reflected on the foreign vehicle 5. The detection device 3 may identify a lane 11 of the route section 2 used by the foreign vehicle 5. Therefore it is possible to relate the foreign driving speed 4 of the foreign vehicle 5 to the lane 11 used by the foreign vehicle 5.

It is also possible for the detection device 3 to detect other features that can be associated with the foreign vehicle 5 or the foreign driving speed 4. For example, a time of day of the measurement of the speed or a category of the foreign vehicle 5 can be detected by the detection device 3. The detection device 3 may also save a current speed limit 12 of the route section 2 which is valid during the time of the measurement. The current speed limit 12 may be detected by the detection device 3 by reading signs giving the current value of the speed limit 12 for the route section 2.

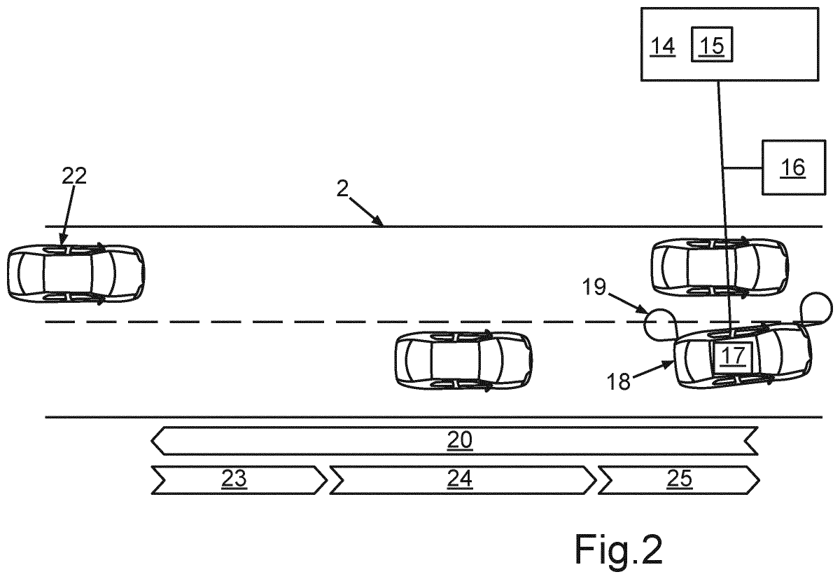

When the detector vehicle 1 drives along the route section 2 the detection device 3 may perform several measurements of foreign driving speeds 4 of foreign vehicles 5 in order to collect larger amount of data and transmit traffic data 13 comprising the foreign driving speeds 4 to a central computer 14 outside the detector vehicle 1. The central computer 14 may receive the traffic data 13 send by the detection device 3. The central computer 13 may analyze the foreign driving speeds 4 in the traffic data 13 to assign one of several speed profiles 15 describing a traffic speed along the route section 2 to the route section using a predefined assignment procedure. The speed profiles 15 may comprise an average traffic speed, an maximum speed, or a distribution of the speed in the route section 2. The central computer 14 may send the speed data 15 in a signal 16 (see FIG. 2) to a lane change assistant 17 situated in an assisted vehicle 18. The lane change assistant 17 may be configured to assist and/or to control a vehicle during a predefined lane change maneuver.

FIG. 2 shows a schematic illustration of a predefined lane change maneuver controlled or assisted by a lane change assistant. The lane change assistant 17 may be configured to start the predefined lane change maneuver of the assisted vehicle 18 or to indicate to a driver of the assisted vehicle 18 that the predefined lane change maneuver is possible by a release signal 19. The release signal 19 may indicate that an execution of the lane change maneuver is released by the lane change assistant 17 and may be performed by the driver. The release of the predefined lane change maneuver may depend on a length of a vehicle free range 20 on a target lane of the predefined lane change maneuver that has to lie within a detection range 21 of the lane change assistant 17 of the assisted vehicle 18. The range 20 may start at a rear end of the assisted vehicle 18. In order for a maneuver to be enabled by the lane change assistant 17, it may be necessary that no vehicle 22 is detected within the range 20. A length of the range 20 may depend on the speed profile 15 assigned to the route section 2 by the central computer 13.

Methods are known to accumulate data from vehicles in the sense of swarm intelligence and to process it on a central server. Procedures are also known that allow a lane change if an ego speed of an assisted vehicle is sufficient to perform a lane change to the target lane. The lane change may be allowed, when a faster vehicle is approaching on the target lane but a distance is far enough. This procedure is based on the assumption about a certain behavior of the foreign vehicle in the case that the ego vehicle would actually perform a lane change. This is composed of reaction distance, braking distance and safety distance, or the input variables: Speed, reaction time, deceleration, minimum safety distance to be set.

The speed of the overtaking vehicle may exceed the locally prescribed speed limit by different amounts in different regions. The lane change assistant 17 estimate of sufficient sensor visibility would then be based on incorrect assumptions.

In the disclosure, the assumption of the maximum speed is improved with the help of swarm data. The initial value should be either the absolute speed or the speed violation of the other traffic participants.

The assumption of the maximum speed is improved by the disclosure and allows an improvement of an availability of data and of a safety.

With the help of the sensors of vehicles 1 in the field comprising the detection device 3, the foreign driving speeds 4 of foreign vehicles 5 may be determined and transmitted to the central computer 14.

There, for example, suitable highway sections with similar speed profiles 15 are determined and summarized on digital maps. Average speeds with standard deviations, for example, may be attributed to these route sections 2.

A digital map comprising the route sections 2 may be enriched with these values and transferred to the assisted vehicles 18 with a lane change assistance function, which can release their lane change depending on the ego speed.

Overall, the example shows how a larger volume of vehicle speed data in a route section can be provided by a vehicle.

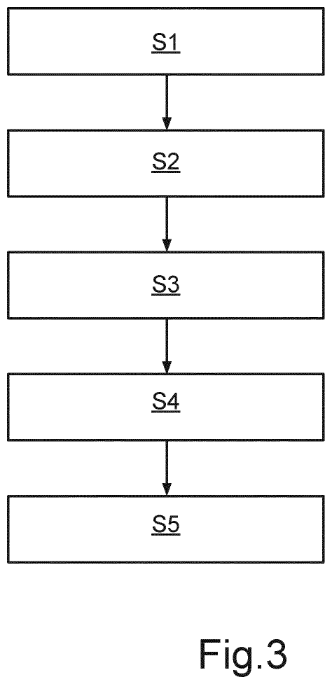

FIG. 3 shows a flowchart of a method for determining a speed of traffic in a route section. At S1, a detection device of a detector vehicle detects at least two absolute positions of a foreign vehicle in the route section. At S2, the detection device of the detector vehicle determines a foreign driving speed of the foreign vehicle in the route section from the at least two absolute positions of the foreign vehicle. At S3, the detection device of the detector vehicle sends traffic data including the foreign driving speed of the foreign vehicle in the route section to a central computer external to the detector vehicle. At S4, the central computer receives the traffic data. At S5, the central computer assigns a speed profile to the route section based on the traffic data by way of a predefined assignment procedure.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for determining a speed of traffic in a route section, the method comprising:
determining, by a detection device of a detector vehicle, a foreign driving speed of a foreign vehicle in the route section according to a predetermined speed determination method; and
sending, by the detection device of the detector vehicle, traffic data including the foreign driving speed of the foreign vehicle in the route section to a central computer external to the detector vehicle.

2. The method according to claim 1, wherein the determining the foreign driving speed of the foreign vehicle in the route section according to the predetermined speed determination method includes:
detecting, by the detection device of the detector vehicle, at least two absolute positions of the foreign vehicle in the route section; and
determining, by the detection device of the detector vehicle, the foreign driving speed of the foreign vehicle in the route section from the at least two absolute positions of the foreign vehicle.

3. The method according to claim 1, wherein the determining the foreign driving speed of the foreign vehicle in the route section according to the predetermined speed determination method includes:
detecting, by the detection device of the detector vehicle, an ego driving speed of the detector vehicle at least once.

4. The method according to claim 3, wherein the determining the foreign driving speed of the foreign vehicle in the route section according to the predetermined speed determination method includes:
detecting, by the detection device of the detector vehicle, at least two relative positions of the foreign vehicle related to the detector vehicle in the route section; and
determining, by the detection device of the detector vehicle, the foreign driving speed of the foreign vehicle in the route section using the at least two relative positions of the foreign vehicle and the ego driving speed of the detector vehicle.

5. The method according to claim 3, wherein the determining the foreign driving speed of the foreign vehicle in the route section according to the predetermined speed determination method includes:
measuring, by the detection device of the detector vehicle, a relative foreign driving speed of the foreign vehicle in the route section; and
determining, by the detection device of the detector vehicle, the foreign driving speed of the foreign vehicle in the route section using the relative foreign driving speed of the foreign vehicle and the ego driving speed of the detector vehicle.

6. The method according to claim 1, wherein the traffic data including the foreign driving speed of the foreign vehicle include a lane used by the foreign vehicle.

7. The method according to claim 1, wherein the traffic data including the foreign driving speed of the foreign vehicle include a current speed limit of the route section.

8. The method according to claim 1, wherein further comprising:
receiving, by the central computer external to the detector vehicle, the traffic data; and
assigning, by the central computer external to the detector vehicle, a speed profile to the route section based on the traffic data.

9. A detection device comprising:
at least one processor; and
at least one memory storing program computer-readable instructions that, when executed by the at least one processor, causes the detection device to:
determine a foreign driving speed of a foreign vehicle in a route section according to a predetermined speed determination method; and
send traffic data including the foreign driving speed of the foreign vehicle in the route section to a central computer external to a detector vehicle.

10. A central computer comprising:
at least one processor; and
at least one memory storing computer-readable instructions that, when executed by the at least one processor, causes the central computer to:
receive traffic data; and
assign a speed profile to a route section based on the traffic data.
